(19) United States
(12) Patent Application Publication
(10) Pub. No.: US 2010/0165639 A1
(43) Pub. Date: Jul. 1, 2010

(54) Light-Transmitting Columbarium Niche Shutter

(76) Inventor: William Skeele, Colorado Springs, CO (US)

Correspondence Address: Brenda L. Speer, LLC, 29 East Moreno Avenue, Colorado Springs, CO, 80903-3915, US

(21) Appl. No.: 12/344,415

(22) Filed: Dec. 26, 2008

(51) Int. Cl. F21V 11/00; F21V 5/00

(52) U.S. Cl. 362/326; 362/351

(57) ABSTRACT

The present invention relates to a niche shutter for a columbarium, in particular, a light-transmitting niche shutter for a columbarium; wherein the transmitted light may be unrefracted or refracted to create a spectrum, projected image or projected inscription within the niche.

### BACKGROUND OF THE INVENTION

1. Field of the Invention

The present invention relates to a niche shutter for a columbarium, in particular, a light-transmitting niche shutter for a columbarium; wherein the transmitted light may be unrefracted or refracted to create a spectrum, projected image or projected inscription within the niche.

2. Description of Related Art Including Information Disclosed Under 37 CFR 1.97 and 37 CFR 1.98

Columbariums and mausoleums containing a plurality of niches for receiving cremains are known. Once a niche has been filled with cremains, either in an urn or other container, or loose, the niche is sealed with a shutter. Typically, a niche shutter is opaque and, thus, prevents light transmission into the interior of the niche. Opaque shutters are usually made of stone or metal so that the shutter may be inscribed or engraved with information regarding the entombed decedent, or decorative elements. Glass niche shutters are known, but are not desirable, because glass shutters are subject to breakage, particularly in outdoor columbariums, are not as easily inscribed as stone or metal shutters, and non-private and enable viewing of the cremains, inurned or otherwise, which is objectionable to some people.

Various ways of personalizing or decorating niche shutters are known in the prior art. For example, U.S. Pat. No. 5,622,014 issued Apr. 22, 1997, by Weiss for a Columbarium with Movable Element discloses a niche shutter which has disposed within and extending through the niche shutter a rotatable element rotatably mounted therein; wherein the rotatable element is a rotatable cylinder upon which may be engraved the life story of the deceased. The rotatable cylinder can be hollow to accommodate cremains.

U.S. Pat. No. 5,625,933 issued May 6, 1997, by Neuberger et al. for a Storage Container and Display for Cremated Remains discloses a storage container which container serves both the function of an urn for storage of cremains and the function of a columbarium niche insert. The container has a panel insert area therein for holding a decorative panel and when numerous containers with such panels are combined into a columbarium, a unitary decorative design is formed on the columbarium.

U.S. Pat. No. 6,088,973 issued Jul. 18, 2000, by Weiss for Monuments, Markers and Columbariums with Improved Display Indicia discloses a columbarium niche shutter, which has disposed within and flush with the front surface, a rotatable element rotatably mounted therein; wherein the rotatable element is a rotatable cylinder upon which may be engraved the life story of the deceased. Weiss also discloses a niche shutter with a secondary plate mounted thereon, which plate has imprints of a deceased individual's hands or other body parts, or other nonverbal indicia.

US Patent Application 2005/0050776 published Mar. 10, 2005, by Tingesdahl for a Crypt Memorialization System discloses an identification and memorialization apparatus comprising a decorative closed frame and at least one identification element removably attached to the frame where the system is removably mounted on the facade or niche shutter of the mausoleum crypt, columbarium or niche.

Non-privacy, glass shutters which transmit light into a niche interior and enable viewing of the contents are known in the prior art. However, a privacy-maintaining, light-transmitting columbarium niche shutter is not known in the prior art, in particular a light-transmitting niche shutter for a columbarium; wherein the transmitted light may be unrefracted or refracted to create a spectrum, projected image or projected inscription within the niche.

### BRIEF SUMMARY OF THE INVENTION

The present invention relates to a niche shutter for a columbarium, in particular, a privacy-maintaining, light-transmitting niche shutter for a columbarium; wherein the transmitted light may be unrefracted or refracted to create a spectrum, projected image or projected inscription within the niche.

### BRIEF DESCRIPTION OF THE SEVERAL VIEWS OF THE DRAWING(S)

FIG. 1 is a side, cross-sectional, perspective view of a columbarium niche with a light-transmitting shutter of the present invention.

FIG. 2 is an exploded, perspective view of a columbarium niche with a light-transmitting shutter of the present invention.

FIG. 3 is side view of a light-transmitting shutter of the present invention.

FIG. 4 is front plan view of a light-transmitting shutter of the present invention.

FIG. 5 is a side, cross-sectional, perspective view of a columbarium niche with a light-transmitting shutter of the present invention.

### LIST OF REFERENCE NUMERALS

2 niche

4 urn

6 projector

8 projector attachment means

10 light transmission device

12 shutter

14 shutter aperture

16 attachment means

18 attachment means through-hole

20 niche closure bracket

22 columbarium

24 attachment means receiving recess

### DETAILED DESCRIPTION OF THE INVENTION

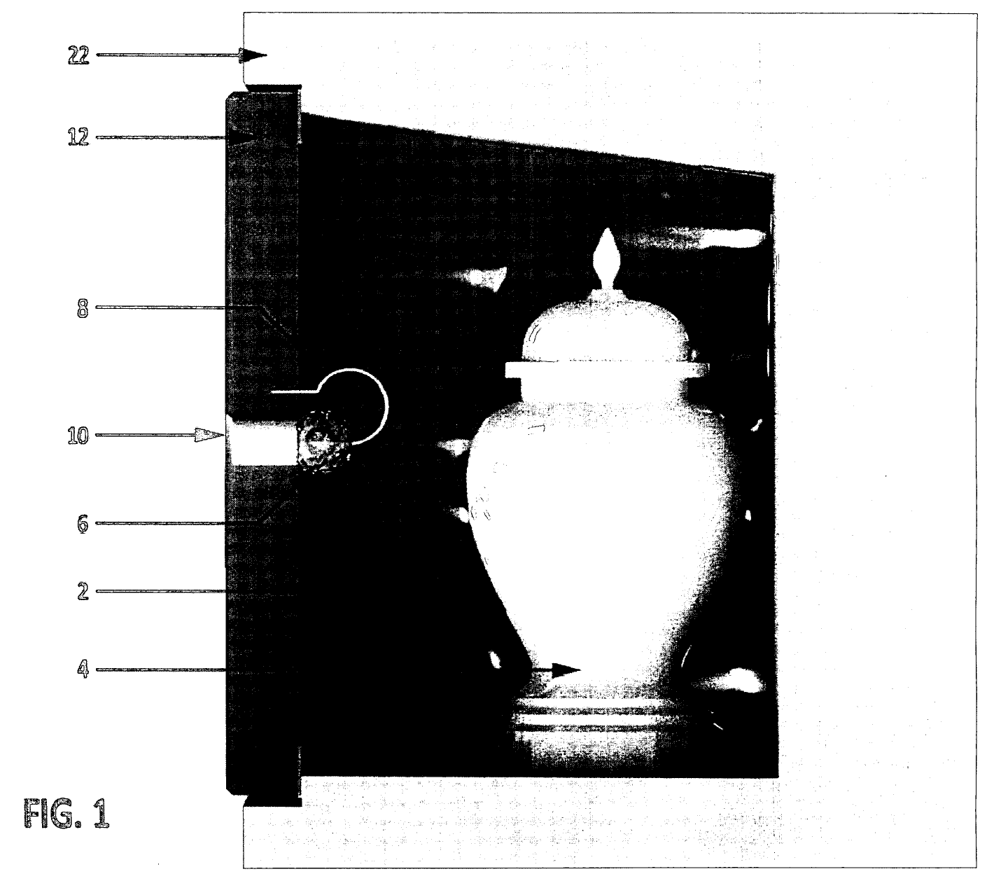

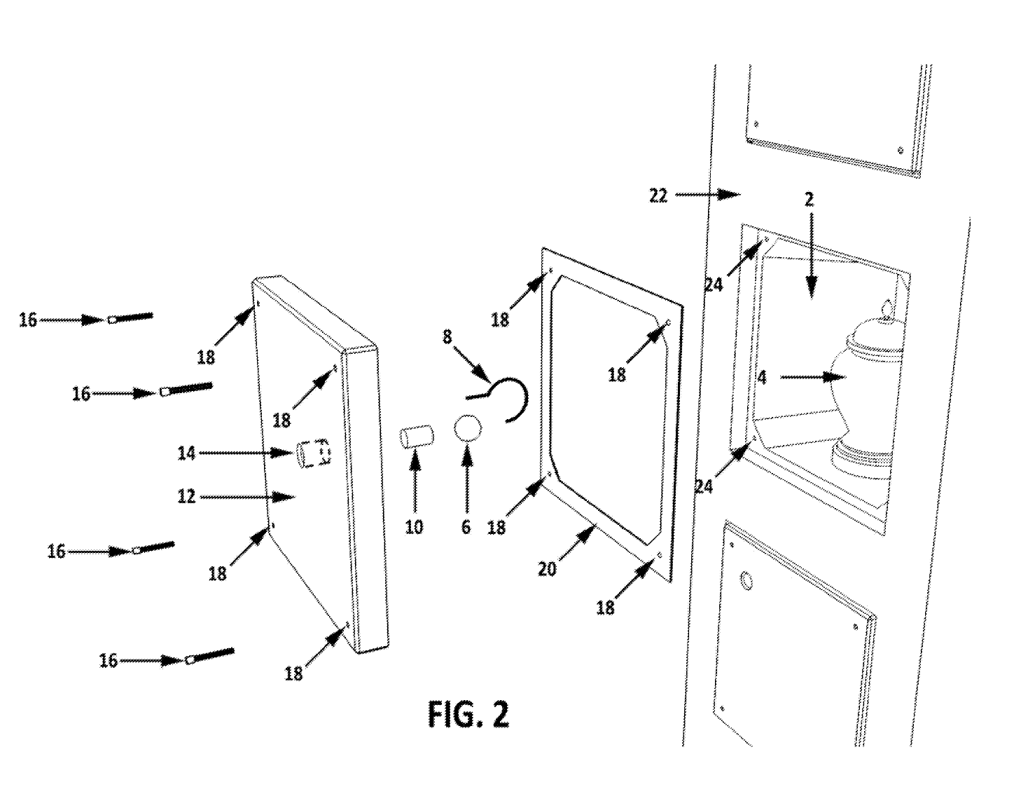

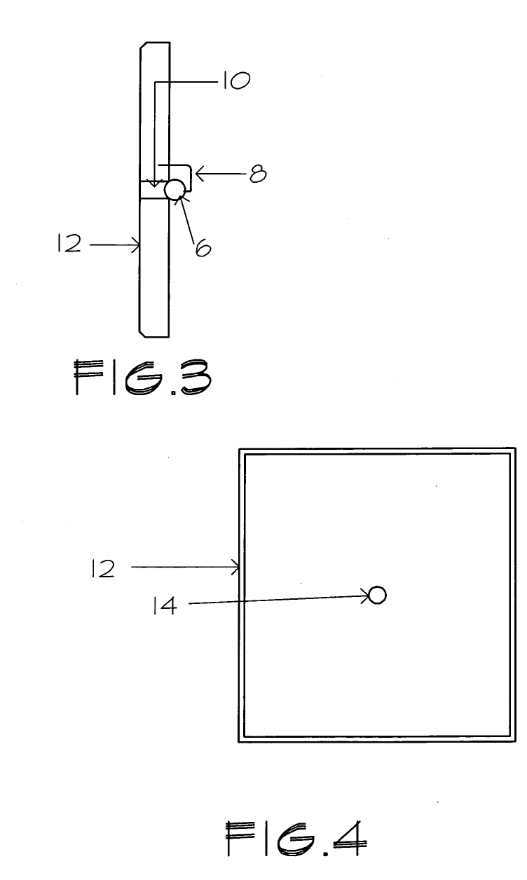

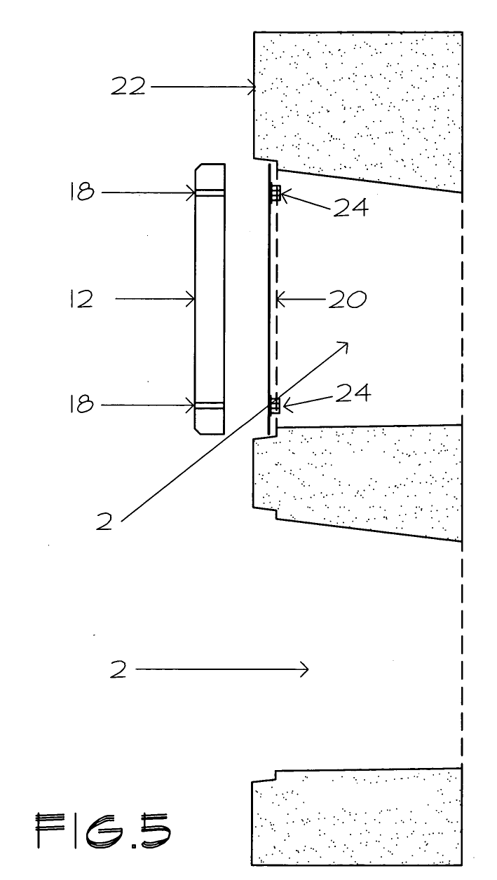

With reference to FIG. 1, an urn 4 is shown within a columbarium 22 niche 2. The niche 2 is closed with a shutter 12. As shown in FIG. 2 and FIG. 4, the shutter 12 has an aperture 14. The shutter aperture 14 may be placed anywhere in the shutter 12 as a user desires. In the preferred embodiment of the present invention, the shutter aperture 14 is placed in approximately the center of the shutter 12.

The light transmission device 10 may be any suitable device to transmit light into the niche 2. The light transmission device 10 may be selected from the group comprising optic fibers, either as a single fiber or as bundled fibers, a clad rod, glass, and the like.

A clad rod, also referred to as an image or light transfer conduit, such as that manufactured by SCHOTT North America, Inc., located in Southbridge, Mass., is used for light or image transfer. A clad rod exhibits excellent transmission properties and is ideal for applications requiring light transmission to isolate or to locate remotely photo sensors and sources of light. A clad rod is made of glass and consists of a high index core material coated with a lower refractive index glass, thus providing total internal reflection. The clad rod or image conduit may also be used to transmit an image from one end of a rigid fiber optic rod and display that image on the opposite rod end. A standard clad rod or image conduit has polished ends and can be bent readily by heating to conform to any prescribed path with minimal transmission loss. Typical applications for a clad rod or image conduit include gyroscopes and optical feedback sensors for night vision systems.

A light transmission device 10 is positioned within the shutter aperture 14. The light transmission device 10 seals the shutter aperture 14 and prevents outside elements, such as air and water, from penetrating the shutter 12 and into the niche 2. The light transmission device 10 transmits ambient light from the exterior of the columbarium 22 and into the interior of the niche 2. Although the light transmission device 10 transmits light into the niche 2, a user cannot see through the light transmission device 10 and into the niche 2, thus, maintaining the privacy of the niche.

The light transmission device 10 may be used by itself and serve to transmit unrefracted light into the niche 2. Alternatively, the light transmission device 10 may be used in conjunction with a projector 6 to project an image or inscription, or to transmit refracted light into the niche 2; wherein the projector 6 is selected from the group comprising a prism, crystal, crystal bead, etched crystal glass, natural crystal and the like. The light refracted by the projector 6 may transmitted into the niche 2 as a unitary spectrum or as a scattered spectrum as depicted in FIG. 1. Alternatively, the projector 6 may be faceted to project a particular image or inscription into the niche 2, such as a cross, star of David, memorial wording, or any other image or inscription desired by a user.

Alternatively, the light transmission device 10 itself may be configured to refract light and to project a spectrum, image or inscription into the interior of the niche 2 without a projector 6. The light transmission device 10 may be shaped or cut, in the instance of a clad rod as the light transmission device 10. The light transmission device 10 may be a fused or shaped optic fibers, in the instance of optic fibers as the light transmission device 10.

With reference to FIG. 1 and FIG. 3, the projector 6 is suspended within the niche 2 in front of the light transmission device 10. The projector 6 is suspended by means of a projector attachment means 8, such as a retention clip or other suitable device. The projector attachment means 8 is attached to the shutter 12 by any suitable means, such as gluing, screwing, mounting or, preferably, by drilling a hole within the shutter 12 to receive and affix the projector attachment means 8 therein. Likewise, the projector 6 is attached to the projector attachment means 8 by any suitable means, such as gluing, screwing, mounting or, preferably, by drilling a hole within the projector 6 to receive and affix the projector attachment means 8 therein. Furthermore, the projector attachment means 8 should be optimally placed in relation to the projector 6 so that the projector attachment means 8 does not interfere with the light, spectrum or image projected from the projector 6 into the niche 2.

With reference to FIG. 2 and FIG. 5, the shutter 12 is mounted securely over a niche 2 opening. The mounting of the shutter 12 over a niche 2 opening may optionally include a niche closure bracket 20. In this embodiment, the niche closure bracket 20 is placed about the niche 2 opening and the shutter 12 is placed over the niche 2. The shutter 12 is secured to the niche by shutter attachment means 16 which pass through attachment means through-holes 18 in the shutter 2 and the niche closure bracket 20 and into attachment means recesses 24 about the niche 2 in the columbarium 22. The shutter attachment means 16 are preferably tamper proof fasteners. The niche closure bracket 20 preferably creates a weather seal about the niche 2 opening, as well as security, to prevent unwanted entry into or opening of the niche 2.

Although the present invention has been described with reference to specific embodiments, it is understood that modifications and variations of the present invention are possible without departing from the scope of the invention, which is defined by the claims set forth below.

The invention claimed is:

1. A light-transmitting columbarium niche shutter comprising:
a. A shutter having an shutter aperture therein; and
b. A light transmission device inserted within said shutter aperture;
Wherein ambient light from an exterior side of said shutter is transmitted via said light transmission device through the shutter and projected into an interior of a columbarium niche.

2. The light-transmitting columbarium niche shutter of claim 1; wherein the ambient light is unrefracted by the light transmission device.

3. The light-transmitting columbarium niche shutter of claim 1; wherein the ambient light is refracted by the light transmission device.

4. The light-transmitting columbarium niche shutter of claim 3; wherein the ambient light is refracted by the light transmission device to project a spectrum, image or inscription into the interior of the columbarium niche.

5. A light-transmitting columbarium niche shutter comprising:
a. A shutter having a shutter aperture therein;
b. A light transmission device inserted within said shutter aperture;
c. A projector attachment means affixed to an interior surface of the shutter; and
d. A projector affixed to said projector attachment means;
Wherein ambient light from an exterior side of said shutter is transmitted via said light transmission device through the shutter, refracted by said projector and projected into an interior of a columbarium niche.

6. The light-transmitting columbarium niche shutter of claim 5; wherein the projector is selected from the group comprising a prism, crystal, crystal bead, etched crystal glass, natural crystal, and the like.

7. The light-transmitting columbarium niche shutter of claim 5; wherein the ambient light is refracted by the projector to project a spectrum, image or inscription into the interior of the columbarium niche.
